(19) United States
(12) Patent Application Publication
(10) Pub. No.: US 2002/0170065 A1
(43) Pub. Date: Nov. 14, 2002

(54) Apparatus and method of managing compression of video and delivery of video over the internet

(76) Inventor: Skyler D. Pinnick, Toronto (CA)

Correspondence Address: Bruce Amson, Chief Operating Officer, Vidigo Corporation, Suite 400, 40 University Avenue, Toronto, ON, M5J-1T1, CA

(21) Appl. No.: 09/853,073

(22) Filed: May 8, 2001

(51) Int. Cl. H04N 7/173; G06F 15/16

(52) U.S. Cl. 725/109; 725/110; 725/87

(57) ABSTRACT

An apparatus and method for compressing video and delivering video over the Internet to users, wherein the video delivered is compressed to the specific variables of the users personal computing device.

This invention relates to a method of managing the compression and delivery of video files to user(s) having multiple viewing capabilities via the Internet and/or World Wide Web (hereinafter referred to collectively as the “Web” and/or “Internet”). For purposes of this invention, the term “video” is comprised of digital video, audio and graphics.

Since each user viewing video over the Internet does so with a personal computing device (“PCD”) many variables are involved that effect a user's viewing experience. If a user can select and download a video file from a Web site or e-mail, open and view that video file using a player without difficulty (i.e. seamlessly) and at the same time receive a high quality television like video, regardless of the connection speed, the user's viewing experience will be maximized. If a user has any problems selecting or downloading a video file, or opening or viewing the file, or receives poor quality video because of a slow connection rate or poorly compressed video, the users viewing experience is lowered.

Variables that effect a user's viewing experience include the user's PCD platform such as personal computer (“PC”) or Macintosh® (“Mac”) or even a handheld wireless device such as a cellular telephone or hand held device such as a Palm Pilot®, the type and version of Web browser used by the user (e.g. Netscape® version 6.0), the type and version of video player used by the user (e.g. QuickTime® version 4.0), and the user's connection speed (e.g. 56 Kbps). Another factor effecting the user viewing experience is related to the compression techniques used on the video.

These variables are growing as software developers and hardware manufacturers continue to develop and release newer versions of their products. The “player” or architecture variable that effects a use's viewing experience arises from the variety of players available over the Web. The players available today may provide users with control selectors such as play, pause, rewind, and fast forward for controlling the viewing of a video.

Currently there are three major players available: QuickTime, RealG2®, and Windows Media Player®. If the video file is only graphics, then the user may require plug-ins such as Flash. A video must be compressed specifically for each player type. In addition to the variety of players, new versions of the players are continuously being released.

The “compression” variable effecting the user viewing experience is related to the compression techniques used to produce video that can be viewed by a user over the Internet. If a video is compressed for users with a high speed connection such as a T1 line, users having a low speed connection such as 56 Kbps, will have a poor viewing experience because the compression technique used on the the video will not be matched to the user's connection speed. For example, a high action video may have to be compressed for high speed connection to obtain an acceptable quality. If a user having a low speed connection views such a video, the video may appear choppy and blurry, and the audio may not be synchronized with the video.

As the delivery of video over the Web becomes more popular and as the number of user variables increase, it is a challenge to those providing video compression and delivery services to increase and maximize a user's viewing experience. It would be preferable to have a method of managing the compression and delivery of video files over the Web to match a user's profile or all of the variables of the specific user viewing the video.

In accordance with the principles of the present invention, a method is described for managing the compression and delivery of video files to users over the Web, wherein the video delivered to that user matches the user's profile or video viewing variables.

In the drawings:

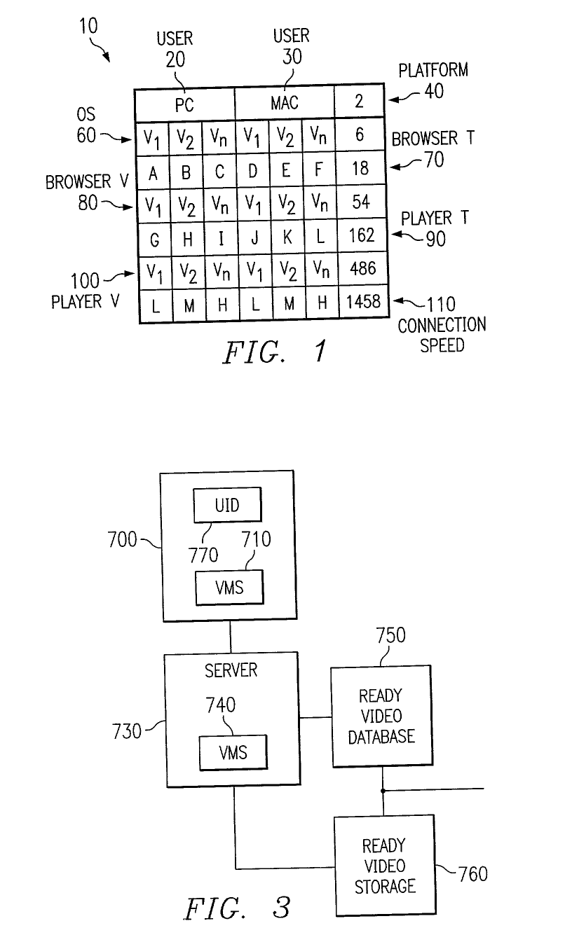

FIG. 1 illustrates a matrix of user variables;

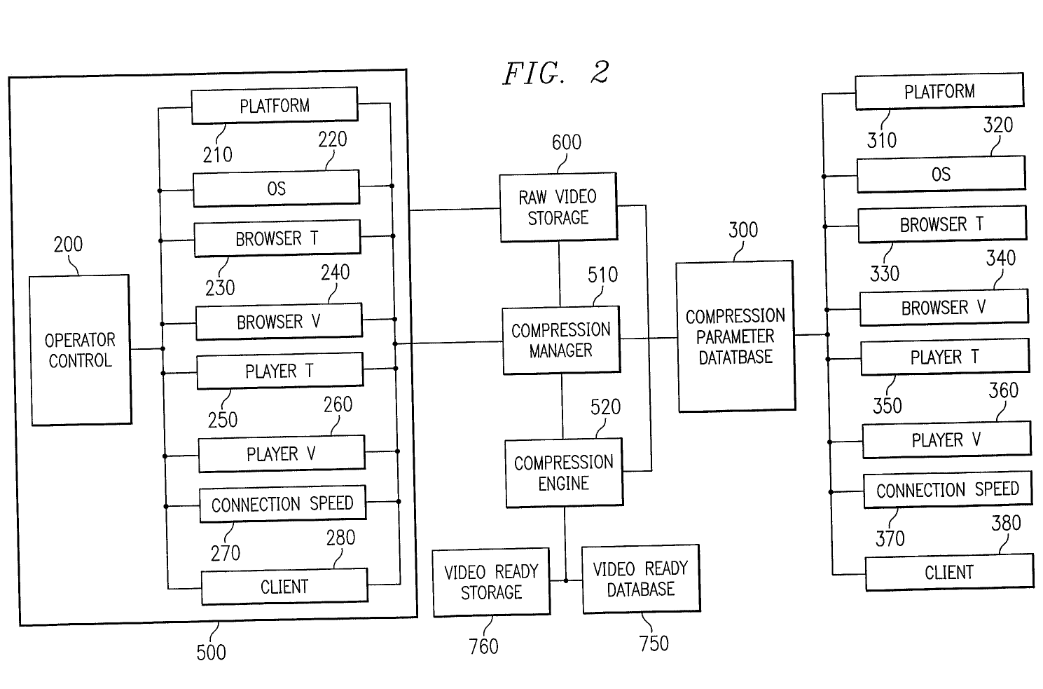

FIG. 2 illustrates a video compression apparatus and method for managing the construction of video files in accordance with the principles of the present invention; and

FIG. 3 illustrates a video delivery apparatus and method for managing user variables in accordance with the principles of the present invention.

Referring first to FIG. 1, a matrix 10 of user variable combinations is shown. The columns of matrix 10 are comprised of PC column 20 and Mac column 30, representing the platform variables, and column 40 representing the total number of variables. The matrix is also comprised of operating system row 60, browser row 70, browser version row 80, player row 90, player version row 100 and connection speed row 110.

Each row of the matrix represents the number of variables for the associated PC column 20 and Mac column 30. For purposes of minimizing the size of FIG. 1, only three versions have been shown for each row. One skilled in the art will readily recognize that the number of variables in each row or column may be increased or decreased as desired to meet market demands. For example, an additional row may be added to the matrix to account for the type of e-mail program that the user is working from and then versions of that e-mail program that want to be supported. Also, an additional column may be added to account for wireless devices such as cellular telephones.

It can be seen by examining only columns 20 and 30, and operating system row 60, that the number of variables is 6. For example, a user having a PC may have version 1, 2 or 3 and a user having a Mac may have versions 1, 2, or 3. Taking only into account the type of platform and the type of operating system,6 video files must be created and stored in a database for delivery to a user to maximize the user experience. Accordingly, when a user having a PC with operating system software version 2 requests a video, a video file compressed to maximize the users viewing experience may be delivered to the user. The process for constructing and selecting such a video is explained below.

In addition, it can be seen from examining connection speed row 110 that a larger number of variables exist if all other variables are taken into account. For example, a user may have a Mac with operating system version 1, browser E, browser version 3, player K, player version 2, and a low (L) connection speed. When columns 20 and 30 and rows 50, 60, 70, 80, 90,100, and 110 are taken into account it can be seen from column 40 that 1,458 separate video files must be compressed accordingly. If certain variables have the same effect upon a user, some videos may be used for serving users with different sets of variables.

Turning now to FIG. 2, compression manager 510 is shown coupled to operator input 500. Operator input 500 is comprised of operator input controls 200, that prompt and permit an operator to enter variables relating to platform 210, operating system 220, browser type 230, browser version 240, player type 250, player version 260, connection speed 270, and customer specific data 280. As stated above, other variables that effect the user viewing experience, such as type of e-mail package, may be added as required.

Customer specific data 280 may include graphical and interactivity elements that can be embedded into the video or attached to the video. For example, a video is viewed through a viewing window and typically surrounded by the graphics of a player, also known as the skin. A skin may be customized for a specific client and added to the video after the video has been compressed. The skin may then accompany the video each time it is viewed by a user.

Compression manager 510 is also coupled to compression parameter database 300. Parameter database 300 stores compression data relating to platform 310, operating system 320, browser type 330, browser version 340, player type 350, player version 360, connection speed 370, and any customer specific data 380. As stated above, data that effects a user viewing experience, such as type of e-mail package, may be added as required. Also coupled to compression manager is raw video storage 600, compression engine 520, ready video database 750, and ready video storage 760.

In operation, an operator may want to compress raw video for a specific client. The client may want its video to be maximized for viewing by a wide variety of users or a narrow group of users. For example, a client may want to focus on users having only a PC with Netscape version 6.0 and higher or Windows Explorer 6.0 or higher, using QuickTime 4.0 and higher, and having a low and medium connection speed.

In that instance, the operator would enter the appropriate variables using operator controls 200. After the variables are entered into platform 210, browser type 230, browser version 240, player type 250 player version 260, and connection speed 270, the operator input will forward that information to Compression Manager 510. Using operator controls 200, the operator will also earmark or identify the location of the client's raw video stored in raw video storage 600. Compression manager 510, will then examine the variables relayed from operator input 500 and task parameter database 300 to retrieve the appropriate compression parameters from platform 310, browser type 330, browser version 340, player type 350, player version 360 and connection speed 370.

After parameter database 300 retrieves and delivers the appropriate compression parameters to compression manager 510, compression manager 510 will send the compression parameters and location of the raw video in raw video storage 600 to compression engine 520. Raw video storage 600 may have multiple formats such as VHS, Beta, DigiBeta or any other available raw video formats.

Once compression engine 520 has received the compression parameters and raw video, it will proceed to compress the separate and distinct videos for all of the possible combinations that a user may have based on the variables entered in by the operator. During that process, compression engine 520 may task compression manager 510 to access additional data from parameter database 300, depending on the number of variables involved. The compression engine may use off the shelf compression software such as Media Cleaner Pro®).

In the example provided above, a separate video will be created for users with a PC, Netscape browser 6.0, QuickTime player version 4.0 and a low speed connection. Another video will be created for users with a PC, Netscape browser 6.0, QuickTime player version 4.0 and a medium speed connection. The compression engine will continue to compress separate videos until all possible combinations have been constructed.

When the compression process is complete for a video, compression engine 520 will notify compression manager 510. Compression manager 510 will then provide compression engine 520 with a location to deliver each of the compressed video files within ready video storage 760. Compression manager 510 or compression engine 520 will also update ready video database 750 as to the location of the compressed video within ready video file storage 760. Once a video is compressed with the appropriate compression parameters, stored in ready video storage 760, and registered with ready database 750, the video may be delivered to a user upon demand.

Turning now to FIG. 3, PCD 700 is shown connected to server 730 via Internet connection 720. Server 730 is linked to ready video database 750 and ready video storage 760. Video manager software (“VMS”) 710 is shown installed on PCD 700 and VMS 740 is shown installed on server 730.

In operation, a user from PCD 700 may request a video file from server 730 through Internet connection 720. Upon such a request, server 730 will query PCD 700 to determine if VMS 710 is installed on the PCD. If VMS 710 is not installed, VMS 740 will prompt the user operating the PCD to accept and install VMS 710. Once VMS 710 is installed on the PCD, or if it was already installed on the PCD, then VMS 710 will create and send a user ID 770 to VMS 740.

User ID 770 will contain all of the variable information about PCD 700. Each time the User ID is requested from VMS 740, VMS 710 will update the User ID by querying the PCD. Since User ID is not based upon the Internet Portal (“IP”) address of the PCD like well know “cookie” files, the data within the User ID may be varied as the user updates and modifies the PCD with software or hardware or as different users select different features of the same PCD. For example, a PCD may be used by a family wherein several members prefer using browser A and some members prefer using browser B. Each time a new member uses the PCD they may run browser A or B. Since VMS 710 updates User ID every time a video is requested by a user, VMS 740 will know what video file to access and deliver from ready video database 750.

If a video has not been constructed that matches the variables received from User ID 770, then VMS 740 will continue to query ready video database 750 to find the closest match. Once a match is found, VMS 740 will retrieve the appropriate video file from video file storage 760 and deliver that video file to PCD 700 via internet connection 720.

The video file may be downloaded from server 730 to PCD 700 using any readily available transfer method such as hypertext transfer protocol (“HTTP”), real-time streaming transfer protocol (“RSTP”), downloading the entire file, or as an e-mail. In addition to requiring that the user operating PCD 100 request a video file, an e-mail may be coded to automatically prompt the delivery of a video file by sending the User ID 770 from PCD 700 to VMS 740 located on Server 730.

What is claimed is:

1. An apparatus for providing video to a user over the Internet comprising:
compression means for compressing a plurality of specialized videos having individual variable configurations;
detection means for detecting user variables on said user's personal computing device;
selection means for selecting said specialized videos matched to said user variables; and
delivery means for delivering said specialized video selected with said selecting means to said user over said Internet.

2. The apparatus of claim 1, wherein said compression means is coupled to an operator interface for entering video compression data.

3. The apparatus of claim 2, wherein said compression means is coupled to a compression paramater database for retreiving compression parameters relative to said video compression data.

4. The apparatuus of claim 3, further comprising a compression manager for managing the construction of said specialized video from said user input and said compression parameters.

5. The apparatus of claim 4, further comprising a compression engine for compressing said specialized video.

6. The apparatus of claim 5, wherein said detection means is comprised of user identification software installed on said user's personal computing device for communicating said user variables.

7. The apparatus of claim 6, further comprising server software installed on a serving computer coupled to the Internet for receiving said user variables from said user identification software.

8. The apparatus of claim 7, wherein said server software is comprised of installation means for installing said user identification software on said user's personal computing device.

9. An apparatus for providing video to users over the Internet comprising:
data entry means for the entry of compression data;
parameter storage means for storing compression parameters;
compression means for compressing a specialized video from said compression data and said compression parameters;
video storage means for storing said specialized video;
detection means for detecting user variables on a said user's personal computing device;
selection means for selecting specialized video matched to said user variables; and
delivery means for delivering said specialized video selected with said selection means.

10. The apparatus of claim 9, wherein said data entry means is comprised of a computer having software for input of client specific data.

11. The apparatus of claim 9, wherein said compression means is coupled to a raw video storage device for storing uncompressed video footage.

12. A method for providing video to a personal computing device over the Internet comprising the steps of:
compressing a plurality of specialized videos having separate user dependent configurations;
detecting the varibles of said personal computing device; and
delivering said specialized video to said personal computing device.
